(19) United States
(12) Patent Application Publication
(10) Pub. No.: US 2023/0153259 A1
(43) Pub. Date: May 18, 2023

(54) DATA TRANSMISSION METHOD AND DATA TRANSMISSION SYSTEM

(71) Applicant: Realtek Semiconductor Corp., HsinChu (TW)

(72) Inventors: Cheng-Yuan Hsiao, HsinChu (TW); Sung-Kao Liu, HsinChu (TW); Chih-Yu Hsu, HsinChu (TW); Wei-Hung Chuang, HsinChu (TW)

(73) Assignee: Realtek Semiconductor Corp., HsinChu (TW)

(21) Appl. No.: 17/692,119

(22) Filed: Mar. 10, 2022

(30) Foreign Application Priority Data
Nov. 17, 2021 (TW) 110142741

(51) Int. Cl. G06F 13/40; G06F 13/38

(52) U.S. Cl. CPC G06F 13/4018; G06F 13/387; G06F 13/4027; G06F 2213/0042

(57) ABSTRACT

A data transmission method, applied to a data transmission system comprising a reception interface and a plurality of transmission interfaces, comprising: (a) receiving first transmission information from a source device via the reception interface, wherein the first transmission information comprises information of data groups corresponding to at least two of the transmission interfaces; and (b) transmitting at least portion of the data groups by a corresponding one of the transmission interfaces in turn to a target device which corresponds to the data group comprising the portion, according to the first transmission information, until transmission of all of the data groups is completed.

### BACKGROUND OF THE INVENTION

### 1. Field of the Invention

The present invention relates to a data transmission method and a data transmission system, and particularly relates to a data transmission method and a data transmission system which can transmit data to a plurality of target devices in turn by a proper sequence.

### 2. Description of the Prior Art

With the development of electronic technology, the transceiving interfaces have become more and more diverse, and the speed thereof become faster and faster. Therefore, the technology of high-speed transceiving interface switching is often used. For example, USB (Universal Serial Bus) to PCIE (peripheral component interconnect express), USB to SATA (Serial Advanced Technology Attachment) and the like.

In order to ensure these high-speed transceiving interfaces to transmit commands smoothly, a command transforming system which is compatible with two different transceiving interfaces is established. Such command transforming systems often face with a situation in which data from one transceiving interface is to be transmitted to a plurality of transceiving interfaces. However, conventional command transforming systems generally lack an appropriate data transfer mechanism.

### SUMMARY OF THE INVENTION

One objective of the present invention is to provide a data transmission method which can use a proper sequence to transmit data to a plurality of target devices.

Another objective of the present invention is to provide a data transmission system which can use a proper sequence to transmit data to a plurality of target devices.

One embodiment of the present invention discloses a data transmission method, applied to a data transmission system comprising a reception interface and a plurality of transmission interfaces, comprising: (a) receiving first transmission information from a source device via the reception interface, wherein the first transmission information comprises information of data groups corresponding to at least two of the transmission interfaces; and (b) transmitting at least portion of the data groups by a corresponding one of the transmission interfaces in turn to a target device which corresponds to the data group comprising the portion, according to the first transmission information, until transmission of all of the data groups is completed.

Another embodiment of the present invention discloses a data transmission system, comprising: a reception interface; a plurality of transmission interfaces; and a controller, wherein the controller controls the reception interface and the transmission interfaces to perform a data transmission method comprising: (a) receiving first transmission information from a source device via the reception interface, wherein the first transmission information comprises information of data groups corresponding to at least two of the transmission interfaces; and (b) transmitting at least portion of the data groups by a corresponding one of the transmission interfaces in turn to a target device which corresponds to the data group comprising the portion, according to the first transmission information, until transmission of all of the data groups is completed.

In view of above-mentioned embodiments, a proper transmission sequence can be acquired if data to be transmitted corresponding to different transmission interfaces is received.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a command transforming system according to one embodiment of the present invention.

FIG. 2 is a block diagram illustrating a data transmission system according to one embodiment of the present invention.

FIG. 3-FIG. 6 are schematic diagrams illustrating operations of the data transmission system according to different embodiments of the present invention.

FIG. 7 is a flow chart illustrating a command transforming method according to one embodiment of the present invention.

### DETAILED DESCRIPTION

Several embodiments are provided in following descriptions to explain the concept of the present invention. Each component in following descriptions can be implemented by hardware (e.g. a device or a circuit) or hardware with software (e.g. a program installed to a processor). Besides, the method in following descriptions can be executed by programs stored in a non-transitory computer readable recording medium such as a hard disk, an optical disc or a memory. Additionally, the term “first”, “second”, “third” in following descriptions are only for the purpose of distinguishing different one elements, and do not mean the sequence of the elements. For example, a first device and a second device only mean these devices can have the same structure but are different devices.

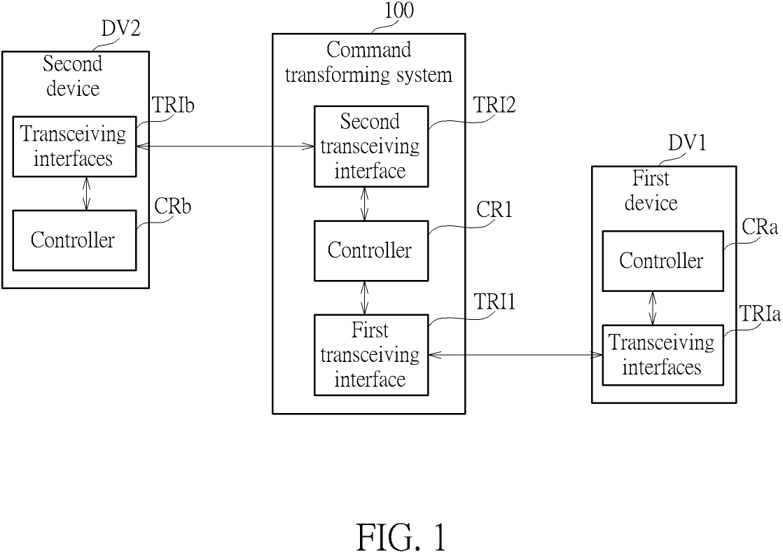

FIG. 1 is a block diagram illustrating a command transforming system 100 according to one embodiment of the present invention. As shown in FIG. 1, the command transforming system 100 comprises a first transceiving interface TRI1, a second transceiving interface TRI2, and a controller CR1. The first transceiving interface TRI1 is configured to receive the command from the first device DV1 and to transmit it to the second transceiving interface TRI2. The second transceiving interface TRI2 is configured to transmit the received command to the second device DV2, and to receive the response from the second device DV2 and transmit the response to the first transceiving interface TRI1. The first transceiving interface TRI1 transmits the response to the first device DV1. The first device DV1 and the second device DV2 may comprise controllers CRa and CRb, respectively, and may also comprise transceiving interfaces TRIa and TRIb, respectively. The first transceiving interface TRI1 can be regarded as a direct interface, and the second transceiving interface TRI2 can be regarded as a non-direct interface. Please also note that the command transforming system 100 may comprise more than one indirect interface. The first device DV1 and the second device DV2 may respectively follow different specifications, and the first transceiving interface TRI1 and the second transceiving interface TRI2 may respectively follow different specifications. Devices that receive data through different transceiving interfaces can also follow different specifications, but must correspond to the transceiving interfaces.

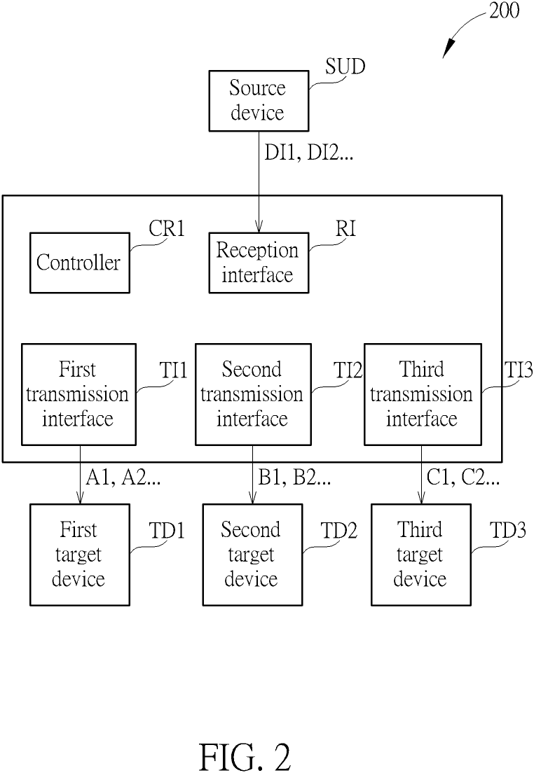

FIG. 2 is a block diagram illustrating a data transmission system according to one embodiment of the present invention. As shown in FIG. 2, the data transmission system 200 comprises a controller CR1, a reception interface RI, and a plurality of transmission interfaces. In the embodiment of FIG. 2, the data transmission system 200 comprises three transmission interfaces: a first transmission interface TI1, a second transmission interface TI2 and a third transmission interface TI3, but the data transmission system provided by the present invention may comprise other numbers of transmissions interfaces. The reception interface RI is configured to receive data and related information from the source device SUD. The first transmission interface TI1, the second transmission interface TI2 and the third transmission interface TI3 are configured to transmit data to a first target device TD1, a second target device TD2 and a third target device TD3, respectively.

The embodiment of FIG. 2 may be implemented by the embodiment of FIG. 1. Specifically, the source device SUD in FIG. 2 can be the first device DV1 in FIG. 1 , the controller CR1 in FIG. 2 can be the controller CR1 in FIG. 1 , and the reception interface in FIG. 2 RI may be the first transceiving interface TRI1 shown in FIG. 1 . The first transmission interface TI1, the second transmission interface TI2 and the third transmission interface TI3 in FIG. 2 may correspond to different indirect interfaces in FIG. 1. However, please note that the data transmission system provided by the present invention is not limited to be implemented by the embodiment in FIG. 1.

Please refer to FIG. 2 again. In the embodiment of FIG. 2, the first transmission information DI1 from the source device SUD is received by the reception interface RI. The first transmission information DI1 comprises information of a plurality of data groups corresponding to at least two of the transmission interfaces. For example, the first transmission information DI1 can inform the data transmission system 200 that there are two data groups (or two pieces of data) to be transmitted at the same time: “The first data group A1, A2... and the second data groups B1, B2. The first data group A1, A2... correspond to the first transmission interface TI1 and the second data groups B1, B2... correspond to the second transmission interface TI2″. The controller CR1 causes the transmission interface in the data transmission system 200 to transmit a portion of the corresponding data group to a corresponding target device in turn according to the first transmission information, until transmission of all data groups are completed. In one embodiment, the controller CR1 controls the transmission interfaces in the data transmission system 200 to transmit a portion of the corresponding data group to a corresponding target device in turn and averagely. Further, in one embodiment, which data group should be transmitted first may be determined by the sequence of the data groups received by the reception interface RI. Alternatively, the source device SUD may inform the data transmission system 200 which data group should be transmitted first.

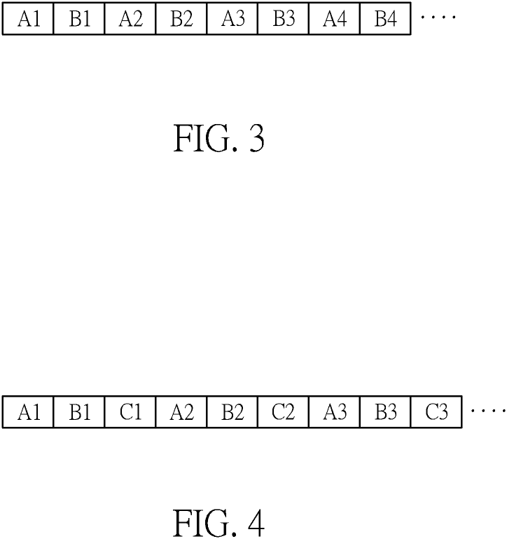

FIG. 3-FIG. 6 are schematic diagrams illustrating operations of the data transmission system according to different embodiments of the present invention. Please note, however, that these embodiments are for only illustration, and do not mean that the scope of the present invention is limited by these operations. In the embodiment shown of FIG. 3, the data transmission system comprises the first transmission interface TI1 and the second transmission interface TI2 shown in FIG. 2, and no transmission interface other than the first transmission interface TI1 and the second transmission interface TI2 is used for transmitting data. In such embodiment, based on the first transmission information DI1, the first data (e.g., A1) of a first portion of a first data group (e.g., A1, A2...) among the data groups is transmitted via the first transmission interface TI1 to a first target device TD1, then the second data (e.g., B1) of a first portion of a second data group (e.g., B1, B2...) among the data groups is transmitted via the second transmission interface TI2 to a second target device TD2, and then the first data (e.g., A2)of a second portion of the first data group A1, A2...is transmitted via the first transmission interface TI1 to the first target device TD1. For more detail, no other data is comprised between the first data (e.g., A1) of the first portion and the second data (e.g., B1) of the first portion. Further, no other data is comprised between the second data (e.g., B1) of the first portion and the first data (e.g., A2) of the second portion. In other words, in the embodiment of FIG. 3, the data to be transmitted is transmitted in turn and averagely via different transmission interfaces.

In the embodiment of FIG. 4, the data transmission system comprises the first transmission interface TI1, the second transmission interface TI2 and the third transmission interface TI3 shown in FIG. 2, and no transmission interface other than the first transmission interface TI1, the second transmission interface TI2 and the third transmission interface TI3 is used for transmitting data. In such embodiment, based on the first transmission information DI1, the first data (e.g., A1) of the first portion of the first data group A1, A2...is transmitted to the first target device TD1 via the first transmission interface TI1, then the second data (e.g., B1) of the first portion of the second data group B1, B2... is transmitted to the second target device TD2 via the second transmission interface TI2, then third data (e.g., C1) of a first portion of a third data group C1, C2... among the data groups is transmitted to a third target device TD3 via the third transmission interface TI3, and then transmitting the first data (e.g., A2) of the second portion of the first data group to the first target device TD1 via the first transmission interface TI1. For more detail, no other data is comprised between the first data (e.g., A1) of the first portion and the second data (e.g., B1) of the first portion. Further, no other data is comprised between the second data (e.g., B1) of the first portion and the third data (e.g., C1) of the first portion. In other words, in the embodiment of FIG. 4, the data to be transmitted by different transmission interfaces are transmitted in turn and averagely.

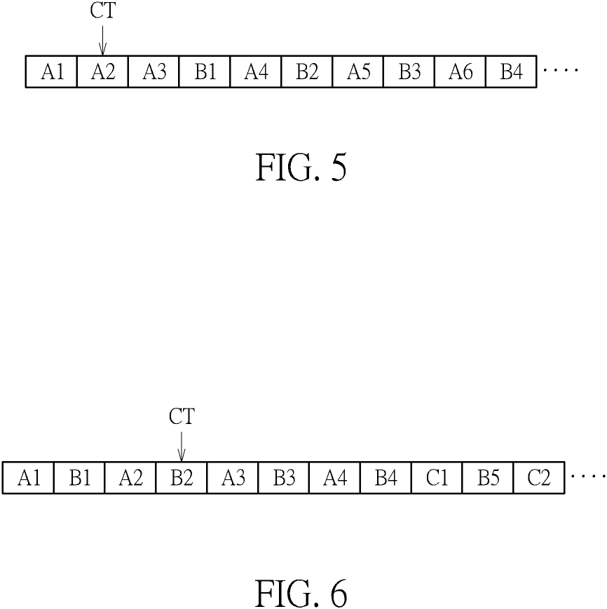

In one embodiment, when the data of one of the data groups is transmitted by one of the transmission interfaces, if the data transmission system 200 receives the second transmission information DI2 via the reception interface RI, it will follow the first transmission information DI1 and the second transmission information DI2 to control the transmission interfaces to transmit a portion of the corresponding data group in turn until all the data groups are transmitted. In other words, when new transmission information is received, a new data transmission sequence will be re-determined according to the previous transmission information and the newly received transmission information. FIGS. 5 and 6 illustrate such examples.

In the embodiment of FIG. 5, originally only the first transmission interface TI1 is used to transmit the first data group A1, A2..., and the second transmission information is received at the time point CT when the first data A2 is transmitted by the second transmission interface DI2. The second transmission information DI2 means that there is a second data group B1, B2 ... to be transmitted via the second transmission interface TI2. Therefore, after the first transmission interface TI1 transmits the first data A3 after the first data A2, the first data group A1, A2 ... and the second data groups B1, B2 ... are transmitted by a new sequence. Specifically, after the first data A3 is transmitted, the first data in the first data group A1, A2... and the second data in the second data group B1, B2... will be transmitted in turn by the sequence of A4, B2, A5, B3.... Please also note that if the speed of the system is fast enough, the data can be transmitted in turn by the sequence of A4, B2, A5, B3... immediately after the first data A2 is transmitted, and it is not limited to wait for the transmission of the next first data A3.

In another embodiment, the first received first transmission information DI1 corresponds to M transmission interfaces among the transmission interfaces, and the second transmission information DI2 received later corresponds to N transmission interfaces among the transmission interfaces. In such example, if the data transmission system 200 first transmits the corresponding data groups via the M transmission interfaces according to the first transmission information DI1, when the data transmission system receives the second transmission information DI2, it will transmit the data corresponding to the M transmission interfaces for one round via the M transmission interfaces first, and then transmit the data corresponding to the M+N transmission interfaces via the M+N transmission interfaces according to the first transmission information DI1 and the second transmission information DI2. The embodiment shown in FIG. 5 corresponds to such example.

Similarly, in the embodiment of FIG. 6, the first transmission information DI1 received first corresponds to two transmission interfaces among the transmission interfaces. Specifically, the first transmission information DI1 means that there is a first data group A1, A2 ... corresponding to the first transmission interface TI1 and a second data group B1, B2 ... corresponding to the second transmission interface TI2 to be transmitted. The second transmission information DI2 received later at the time point CT means that there is a third data group C1, C2 ... corresponding to the third transmission interface TI3 to be transmitted. In such embodiment, since the second transmission information DI2 is received when the second data B2 is transmitted, the first data A3 and the second data B3 corresponding to the first transmission interface TI1 and the second transmission interface TI2 respectively are first transmitted for one round. After that, the data of the first data group A1, A2..., the second data group B1, B2... and the third data group C1, C2... are transmitted in turn. For example, in the embodiment of FIG. 6, data of three data groups are transmitted by the sequence of A4, B4, C1, A5, B5, and C2.

As mentioned above, different transceiving interfaces may respectively follow different specifications, and electronic devices that receive data through different transceiving interfaces must correspond to the transceiving interfaces. In one embodiment, the first transmission interface TI1 in FIG. 2 follows the USB specification, the second transmission interface TI2 follows the SD express specification, and the third transmission interface TI3 is a network card following the NIC (network interface controller) specification. The first target device TD1 is a USB device (such as a USB device in a mobile phone), the second target device TD2 is an SD (Secure Digital) memory card, and the third target device TD3 is an electronic device which can use a network. The reception interface RI also follows the USB specification, and the source device SUD is a USB device (e.g., a USB device in a computer host).

In such embodiment, if the operations in FIG. 4 are to be performed, the source device SUD transmit USB SCSI (Small Computer System Interface) data (the first data group A1, A2, A3...), SD SCSI data (the second data group B1, B2, B3...)and TCPIP packets (the third data group C1, C2, C3...) to the reception interface RI, and informs which data is to be transmitted via USB packets. The source device SUD can also inform the data transmission system 200 that the transmission sequence is USB SCSI data, SD SCSI data and then TCPIP packets . After the data transmission system 200 confirms the sequence, it initiates a control packet (e.g., Erdy) in the USB specification, and then transmits a portion of the USB SCSI data (e.g., A1), then transmits a portion of the SD SCSI data (e.g., B1), and then transmit a portion of the TCPIP packet data (e.g., C1).

If the operations in FIG. 5 are to be performed, the source device SUD transmits USB SCSI (Small Computer System Interface) data to the reception interface RI. The source device SUD informs the data transmission system 200 that the transmission sequence is USB SCSI data. After the data transmission system 200 confirms the sequence, it initiates a control packet (e.g., Erdy) in the USB specification, and then transmits a portion of the USB SCSI data (e.g., A1 ). When the data transmission system 200 processes the first data A2, the source device SUD informs the data transmission system 200 that there is SD SCSI data corresponding to the second transmission interface TI2 to be transmitted. The data transmission system 200 redefines the transmission sequence and then transmits the first data A3 by the same sequence in the next round, and then transmits the data by the new sequence. When transmitting SD SCSI data, the data transmission system 200 initiate a control packet in the USB specification and then transmit the SD SCSI data. The operations of the embodiment of FIG. 6 are similar to which of the embodiment of FIG. 5, except that a number of the transmission interfaces for transmitting data in turn is changed to three, so the details are omitted for brevity here.

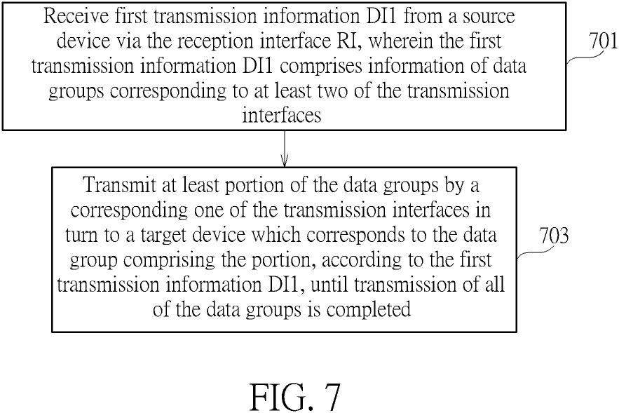

In view of above-mentioned embodiments, a data transmission method can be acquired, which is used in a data transmission system (e.g., the data transmission system 200 in FIG. 2 ) comprising a reception interface and a plurality of transmission interfaces. FIG. 7 is a flow chart illustrating a command transforming method according to one embodiment of the present invention, which comprises the following steps:

### Step 701

Receive first transmission information DI1 from a source device via the reception interface RI, wherein the first transmission information DI1 comprises information of data groups corresponding to at least two of the transmission interfaces.

### Step 703

Transmit at least portion of the data groups by a corresponding one of the transmission interfaces in turn to a target device which corresponds to the data group comprising the portion, according to the first transmission information DI1, until transmission of all of the data groups is completed.

In view of above-mentioned embodiments, a proper transmission sequence can be acquired if data to be transmitted corresponding to different transmission interfaces is received.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data transmission method, applied to a data transmission system comprising a reception interface and a plurality of transmission interfaces, comprising:
(a) receiving first transmission information from a source device via the reception interface, wherein the first transmission information comprises information of data groups corresponding to at least two of the transmission interfaces; and
(b) transmitting at least portion of the data groups by a corresponding one of the transmission interfaces in turn to a target device which corresponds to the data group comprising the portion, according to the first transmission information, until transmission of all of the data groups is completed.

2. The data transmission method of claim 1, wherein the step (b) transmits the portion of the data groups by the corresponding one of the transmission interfaces in turn and averagely to the target device, according to the first transmission information, until transmission of all of the data groups is completed.

3. The data transmission method of claim 1, wherein the transmission interfaces comprises a first transmission interface and a second transmission interface, wherein the step (b) comprises:
based on the first transmission information, transmitting first data of a first portion of a first data group among the data groups to a first target device via the first transmission interface, then transmitting second data of a first portion of a second data group among the data groups to a second target device via the second transmission interface, and then transmitting the first data of a second portion of the first data group to the first target device.

4. The data transmission method of claim 3, wherein the transmission interfaces further comprises a third transmission interface, wherein the step (b) comprises:
based on the first transmission information, transmitting the first data of the first portion of the first data group to the first target device via the first transmission interface, then transmitting the second data of the first portion of the second data group to the second target device via the second transmission interface, then transmitting third data of a first portion of a third data group among the data groups to a third target device via the third transmission interface, and then transmitting the first data of the second portion of the first data group to the first target device.

5. The data transmission method of claim 1, further comprising:
transmitting potions of corresponding ones of the groups by the transmission interfaces in turn according to the first transmission information and the second transmission information if the reception interface receives second transmission information while the transmission interface transmitting data of one of the data groups, until transmission of all of the data groups is completed.

6. The data transmission method of claim 5, wherein the first transmission information corresponds to M transmission interfaces among the transmission interfaces, and the second transmission information corresponds to N transmission interfaces among the transmission interfaces, wherein the data transmission method comprises:
transmitting the data corresponding to the M transmission interfaces for one round via the M transmission interfaces first after the data transmission system receives the second transmission information, and then transmitting the data corresponding to the M+N transmission interfaces via the M+N transmission interfaces according to the first transmission information and the second transmission information.

7. The data transmission method of claim 1, wherein the transmission interfaces follow different specifications.

8. The data transmission method of claim 7, wherein the transmission interfaces comprises a first transmission interface and a second transmission interface, wherein the first transmission interface follows a USB specification and the second transmission interface follows an SD express specification.

9. The data transmission method of claim 8, wherein the transmission interfaces further comprises a third transmission interface following a NIC specification.

10. A data transmission system, comprising:
a reception interface;
a plurality of transmission interfaces; and
a controller, wherein the controller controls the reception interface and the transmission interfaces to perform a data transmission method comprising:
(a) receiving first transmission information from a source device via the reception interface, wherein the first transmission information comprises information of data groups corresponding to at least two of the transmission interfaces; and
(b) transmitting at least portion of the data groups by a corresponding one of the transmission interfaces in turn to a target device which corresponds to the data group comprising the portion, according to the first transmission information, until transmission of all of the data groups is completed.

11. The data transmission system of claim 10, wherein the step (b) transmits the portion of the data groups by the corresponding one of the transmission interfaces in turn and averagely to the target device, according to the first transmission information, until transmission of all of the data groups is completed.

12. The data transmission system of claim 10, wherein the transmission interfaces comprises a first transmission interface and a second transmission interface, wherein the step (b) comprises:
based on the first transmission information, transmitting first data of a first portion of a first data group among the data groups to a first target device via the first transmission interface, then transmitting second data of a first portion of a second data group among the data groups to a second target device via the second transmission interface, and then transmitting the first data of a second portion of the first data group to the first target device.

13. The data transmission system of claim 12, wherein the transmission interfaces further comprises a third transmission interface, wherein the step (b) comprises:
based on the first transmission information, transmitting the first data of the first portion of the first data group to the first target device via the first transmission interface, then transmitting the second data of the first portion of the second data group to the second target device via the second transmission interface, then transmitting third data of a first portion of a third data group among the data groups to a third target device via the third transmission interface, and then transmitting the first data of the second portion of the first data group to the first target device.

14. The data transmission system of claim 10, wherein the data transmission method further comprises:
transmitting potions of corresponding ones of the groups by the transmission interfaces in turn according to the first transmission information and the second transmission information if the reception interface receives second transmission information while the transmission interface transmitting data of one of the data groups, until transmission of all of the data groups is completed.

15. The data transmission system of claim 14, wherein the first transmission information corresponds to M transmission interfaces among the transmission interfaces, and the second transmission information corresponds to N transmission interfaces among the transmission interfaces, wherein the data transmission method comprises:
transmitting the data corresponding to the M transmission interfaces for one round via the M transmission interfaces first after the data transmission system receives the second transmission information, and then transmitting the data corresponding to the M+N transmission interfaces via the M+N transmission interfaces according to the first transmission information and the second transmission information.

16. The data transmission system of claim 10, wherein the transmission interfaces follow different specifications.

17. The data transmission system of claim 16, wherein the transmission interfaces comprises a first transmission interface and a second transmission interface, wherein the first transmission interface follows a USB specification and the second transmission interface follows an SD express specification.

18. The data transmission system of claim 17, wherein the transmission interfaces further comprises a third transmission interface following a NIC specification.
